(19) United States
(12) Patent Application Publication
(10) Pub. No.: US 2016/0332285 A1
(43) Pub. Date: Nov. 17, 2016

(54) Allen Wrench Structure

(71) Applicant: Joun-Jan Chen, Taichung (TW)

(72) Inventor: Joun-Jan Chen, Taichung (TW)

(21) Appl. No.: 14/887,432

(22) Filed: Oct. 20, 2015

Related U.S. Application Data
(63) Continuation-in-part of application No. 29/527,046, filed on May 15, 2015.

(51) Int. Cl. B25B 15/00; B25B 27/18

(52) U.S. Cl. CPC B25B 15/008; B25B 27/18

(57) ABSTRACT

An Allen wrench structure contains: at least one operating segment formed on a gripping handle and having plural hexagonal cross-sectional faces, wherein the at least one operating segment has a first cross-sectional face and a second cross-sectional face. A diameter L1 of an inscribed circle of the first cross-sectional face is less than a diameter L2 of an inscribed circle of the second cross-sectional face, and a working part of the at least one operation segment between the first cross-sectional face and the second cross-sectional face is conical. A misalignment angle θ1 is defined between the first cross-sectional face and the second cross-sectional face so that among six vertices of the first cross-sectional face and six vertices of the second cross-sectional face are defined six extending edges, and each extending edge is defined between each vertex of the first cross-sectional face and each vertex of the second cross-sectional face.

### FIELD OF THE INVENTION

The present invention relates to an Allen wrench structure which does not abrade a hexagonal orifice of a normal screw bolt and removes an abraded screw bolt easily.

### BACKGROUND OF THE INVENTION

Referring to FIG. 1, a conventional Allen wrench 10 is employed to remove a screw bolt 11 with a hexagonal orifice 111 and contains at least one operating segment 102 formed on a gripping handle 101, wherein a plurality of cross-sectional faces of the at least one operating segment 102 are in a hexagon shape and have a same size and a same alignment angle. In operation, the at least one operating segment 102 fits with the hexagonal orifice 111 of the screw bolt 11 so as to remove the screw bolt 11. Referring to FIG. 2, when the at least one operating segment 102 fits with the hexagonal orifice 111 of the screw bolt 11, six peak edges 103 of the at least one operating segment 102 cannot abut against six corners 112 of the hexagonal orifice 111 completely, because an error exists on each of the at least one operating segment 102 of the Allen wrench 10 and the hexagonal orifice 111 of the screw bolt 11, hence a gap defines between the at least one operating segment 102 and the hexagonal orifice 111, and the six peak edges 103 of the at least one operating segment 102 actually abut against six peripheral faces 113 of the hexagonal orifice 111 to rotate the screw bolt 11. However, the six peripheral faces 113 of the hexagonal orifice 111 are abraded by the six peak edges 103 of the at least one operating segment 102, as shown in FIG. 3, so this conventional Allen wrench cannot rotate the screw bolt 11.

As illustrated in FIGS. 4 and 5, another Allen wrench contains an operating segment 201 formed on a gripping handle 20 and a slot 202 defined in a diagonal direction of the operating segment 201, and the operating segment 201 has a threaded aperture 203 arranged on one side thereof to screw a screwing element 21. As removing an abraded screw bolt 22, the screwing element 21 is screwed into the slot 202 so that the operating segment 201 expands outwardly from the slot 202, and the operating segment 201 forms an irregular hexagon to abut against six peripheral faces of an abraded aperture 221, thus rotating the abraded screw bolt 22. Nevertheless, this conventional Allen wrench cannot prevent an abrasion of a normal screw bolt, and an expanding distance of the operating segment 201 is adjusted based on abrasion of the abraded screw bolt so that the operating segment 201 contacts with the abraded aperture 221, thereby causing troublesome removal of the abraded screw bolt.

With reference to FIG. 6, a hexagonal wrench 30 is disclosed in U.S. Pat. No. 9,061,401 and contains a gripping segment 31 and an operating segment 32, wherein the gripping segment 31 has a first fitting portion 311, the operating segment 32 has a second fitting portion 321, axial lines of the first fitting portion 311 and axial lines of the second fitting portion 321 are parallel to a central axis of the hexagonal wrench 30, and first extending sections 312 of the first fitting portion 311 and second extending sections 322 of the second fitting portion 321 are not parallel to the central axis of the hexagonal wrench 30, such that when the first fitting portion 311 or the second fitting portion 321 fits with a hexagonal orifice of the screw bolt and is rotated, the hexagonal wrench 30 rotates the screw bolt forcefully. But the first fitting portion 311 and the second fitting portion 321 abrade the hexagonal orifice of the screw bolt easily, and they cannot rotate an abraded screw bolt.

The present invention has arisen to mitigate and/or obviate the afore-described disadvantages.

### SUMMARY OF THE INVENTION

The primary objective of the present invention is to provide an Allen wrench structure which does not abrade a hexagonal orifice of a normal screw bolt and removes an abraded screw bolt easily.

To obtain above-mentioned objective, an Allen wrench structure provided by the present invention contains: at least one operating segment formed on a gripping handle, and the at least one operating segment has plural cross-sectional faces, each cross-sectional face is formed in a hexogen shape, a first cross-sectional face is defined on a first end of the at least one operating segment, and a second cross-sectional face is defined on a second end of the at least one operating segment.

A diameter L1 of an inscribed circle of the first cross-sectional face is less than a diameter L2 of an inscribed circle of the second cross-sectional face, and a working part of the at least one operation segment between the first cross-sectional face and the second cross-sectional face is in a cone shape, and wherein a misalignment angle θ1 is defined between the first cross-sectional face and the second cross-sectional face so that among six vertices of the first cross-sectional face and six vertices of the second cross-sectional face are defined six extending edges, and each extending edge is defined between each vertex of the first cross-sectional face and each vertex of the second cross-sectional face.

### BRIEF DESCRIPTION OF THE DRAWINGS

FIG. 1 is a perspective view showing the application of a conventional Allen wrench.

FIG. 2 is a cross sectional view showing the operation of the conventional Allen wrench.

FIG. 3 is a cross sectional view of an abraded screw bolt.

FIG. 4 is a perspective view of another conventional Allen wrench.

FIG. 5 is a cross sectional view showing the operation of said another conventional Allen wrench

FIG. 6 is a perspective view of a conventional hexagonal wrench disclosed in U.S. Pat. No. 9,061,401.

FIG. 7 is a perspective view showing the assembly of an Allen wrench structure according to a first embodiment of the present invention.

FIG. 8 is a side plane view showing the assembly of the Allen wrench structure according to the first embodiment of the present invention.

FIG. 9 is a cross sectional view taken the line A-A of FIG. 8.

FIG. 10 is a cross sectional view taken the line B-B of FIG. 8.

FIG. 11 is a side plane view showing the assembly of a first operating segment of the Allen wrench structure according to the first embodiment of the present invention.

FIG. 12 is a perspective view showing the operation of the Allen wrench structure according to the first embodiment of the present invention.

FIG. 13 is a cross sectional view showing the operation of the Allen wrench structure according to the first embodiment of the present invention.

FIG. 14 is another perspective view showing the operation of the Allen wrench structure according to the first embodiment of the present invention.

FIG. 15 is another cross sectional view showing the operation of the Allen wrench structure according to the first embodiment of the present invention.

FIG. 16 is a perspective view showing the assembly of an Allen wrench structure according to a second embodiment of the present invention.

FIG. 17 is a side plane view showing the assembly of the Allen wrench structure according to the second embodiment of the present invention.

FIG. 18 is a cross sectional view taken the line C-C of FIG. 17.

FIG. 19 is a cross sectional view taken the line D-D of FIG. 17.

FIG. 20 is a cross sectional view taken the line E-E of FIG. 17.

FIG. 21 is a perspective view showing the operation of the Allen wrench structure according to the second embodiment of the present invention.

FIG. 22 is a cross sectional view showing the operation of the Allen wrench structure according to the second embodiment of the present invention.

FIG. 23 is another perspective view showing the operation of the Allen wrench structure according to the second embodiment of the present invention.

FIG. 24 is another cross sectional view showing the operation of the Allen wrench structure according to the second embodiment of the present invention.

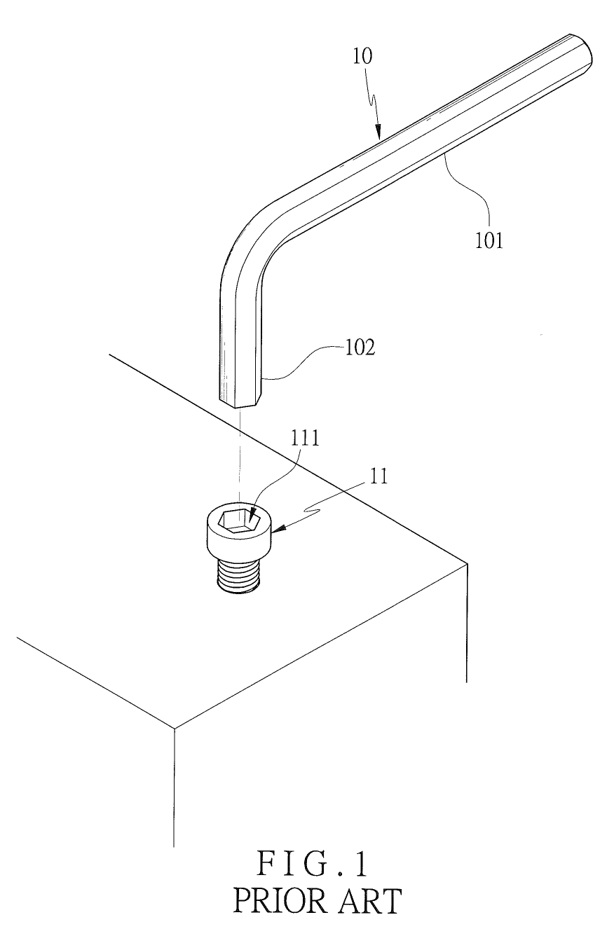

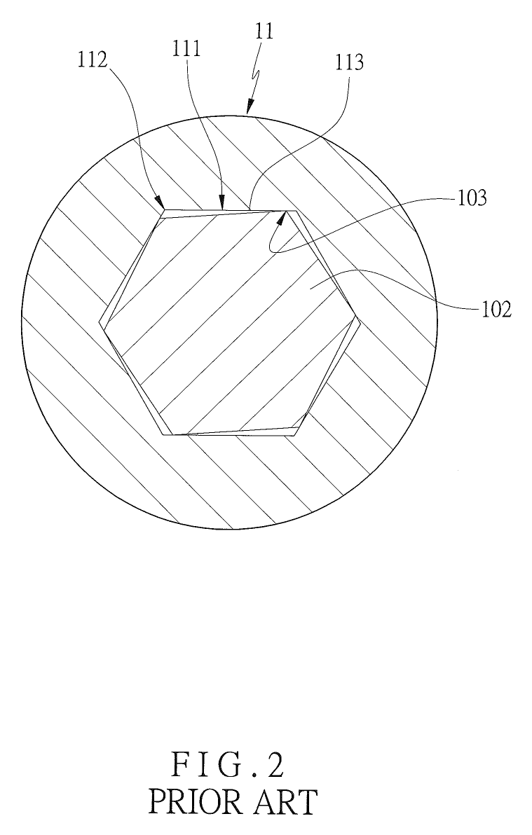

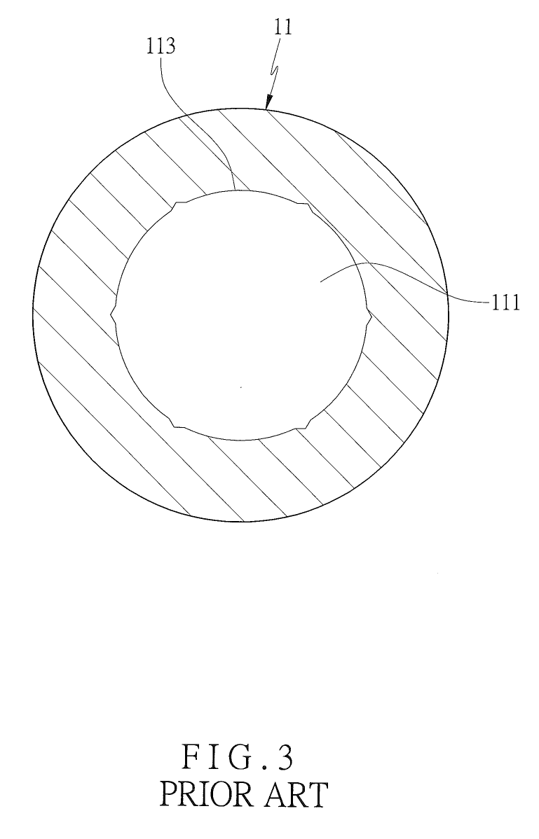

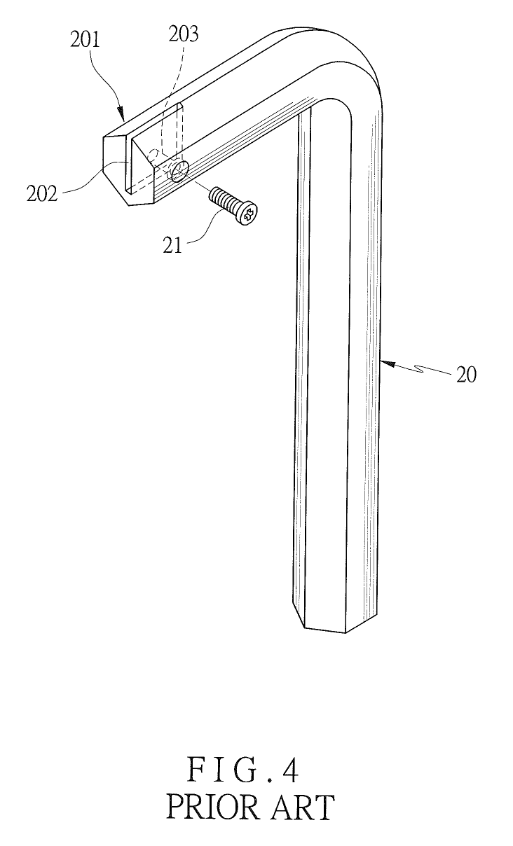

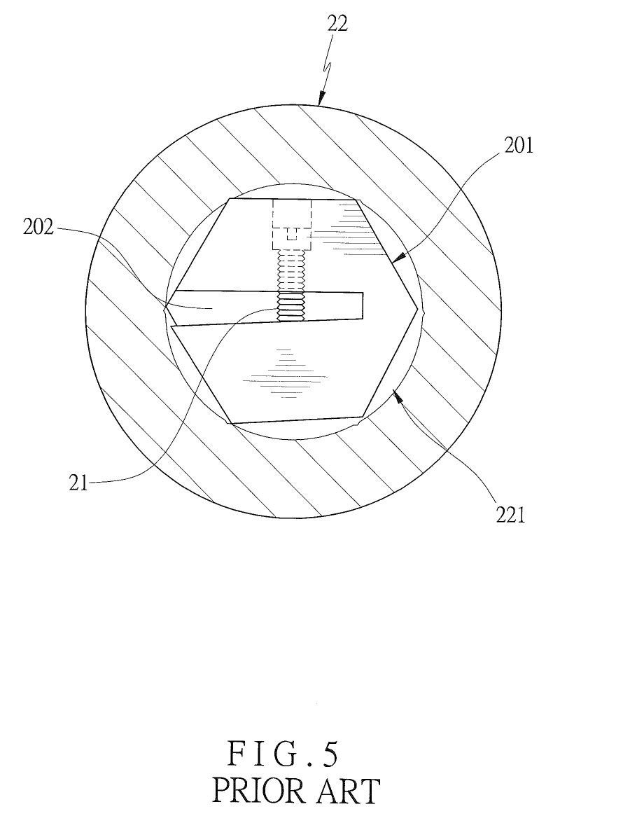

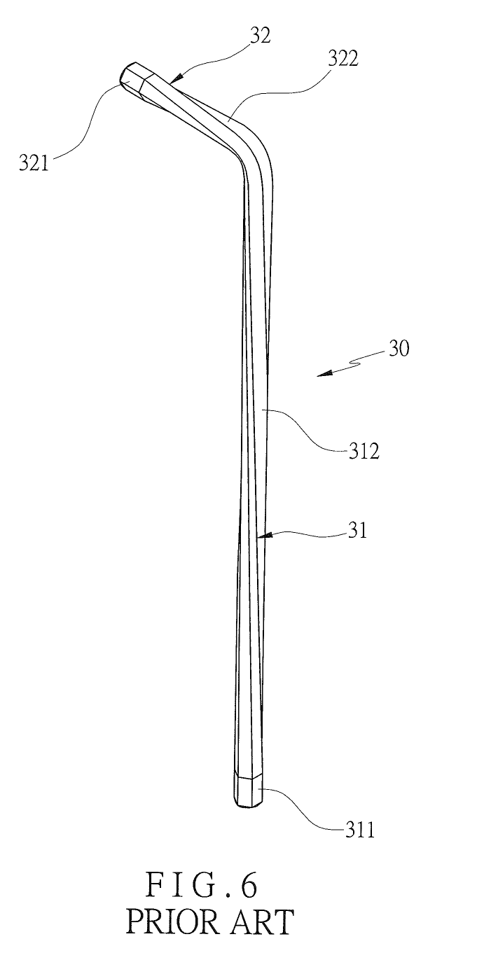

### DETAILED DESCRIPTION OF THE PREFERRED EMBODIMENTS

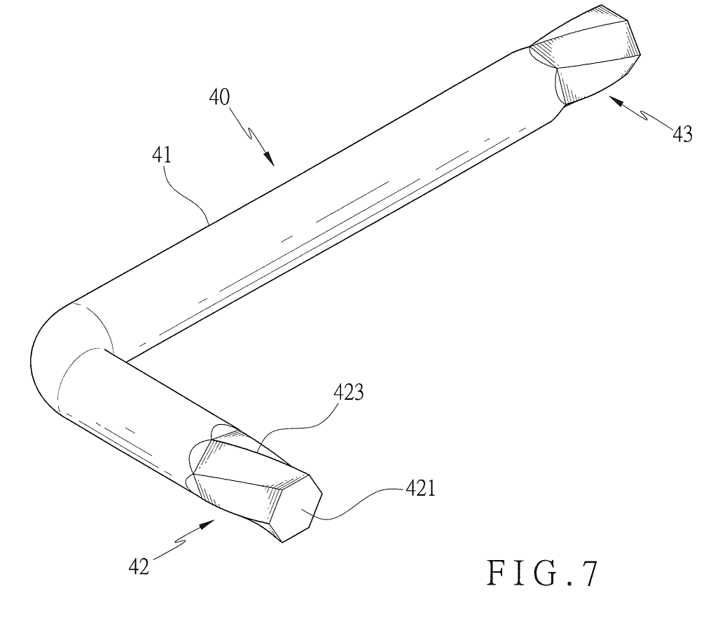

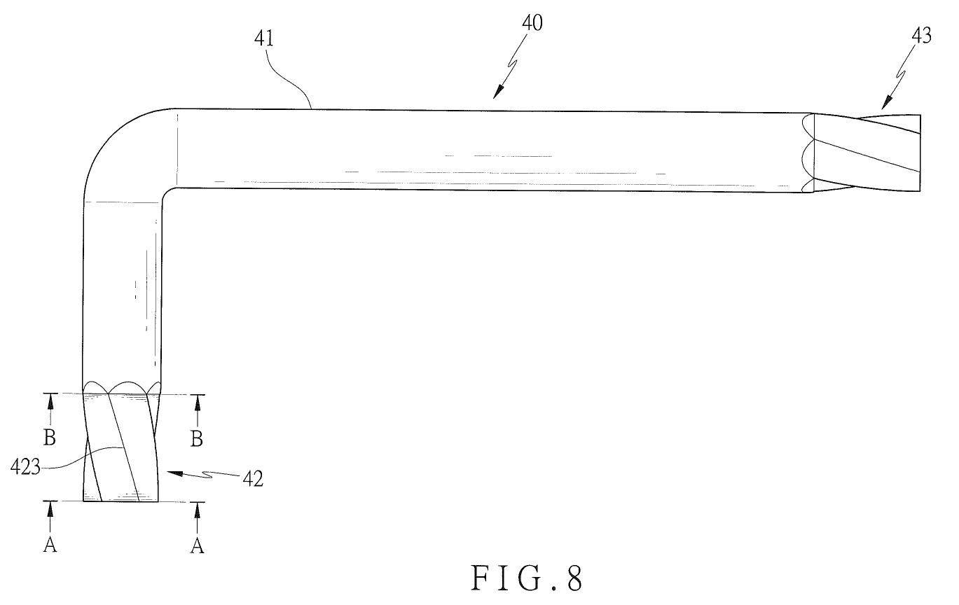

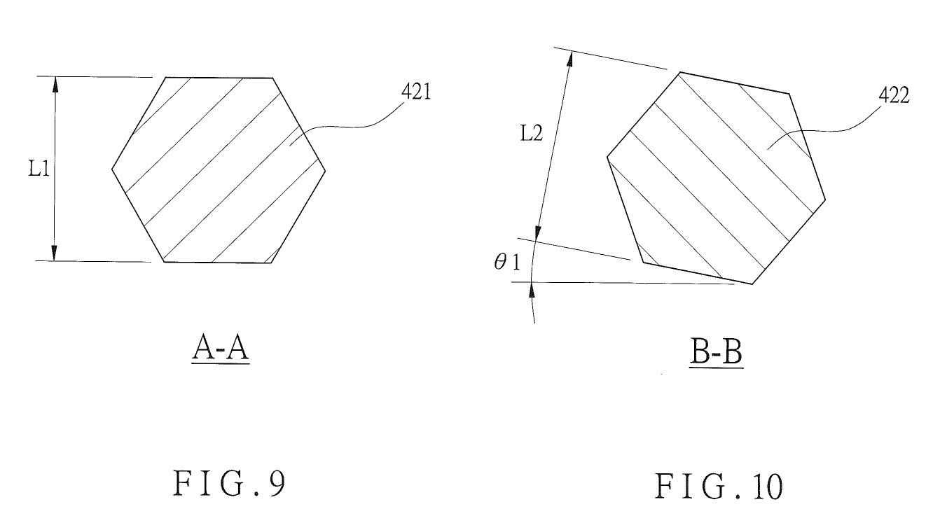

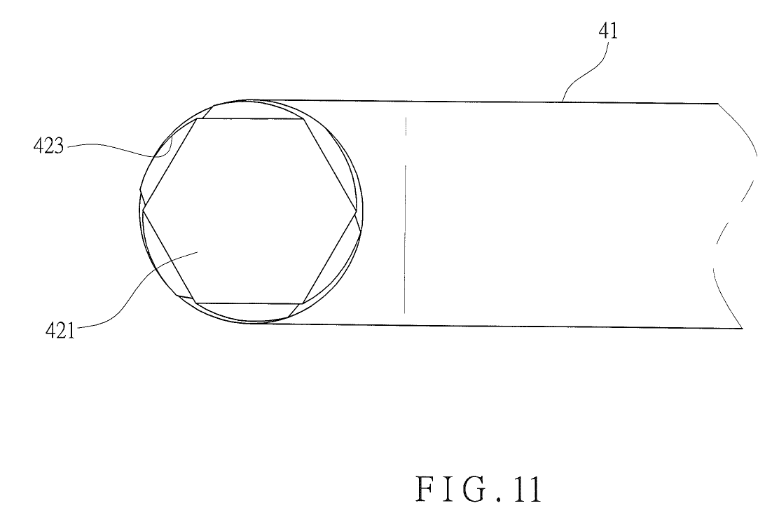

With reference to FIGS. 7 to 11, an Allen wrench 40 according to a first embodiment of the present invention comprises: at least one operating segment formed on a gripping handle 41. In this embodiment, the gripping handle 41 is in an L shape and includes a first operating segment 42 formed on a first end thereof and a second operating segment 43 formed on a second end thereof. The first operating segment 42 is formed in a hexagonal column shape and has a first cross-sectional face 421 defined on a first end thereof, the first operating segment 42 also has a second cross-sectional face 422 defined on a second end thereof; wherein a diameter L1 of an inscribed circle of the first cross-sectional face 421 is less than a diameter L2 of an inscribed circle of the second cross-sectional face 422, and a working part of the first operation segment 42 between the first cross-sectional face 421 and the second cross-sectional face 422 is in a cone shape, wherein the diameter L1 of the inscribed circle of the first cross-sectional face 421 is 0.8 to 0.95 times less than the diameter L2 of the inscribed circle of the second cross-sectional face 422. A misalignment angle θ1 is defined between the first cross-sectional face 421 and the second cross-sectional face 422 so that among six vertices of the first cross-sectional face 421 and six vertices of the second cross-sectional face 422 are defined six extending edges 423, and each extending edge 423 is defined between each vertex of the first cross-sectional face 421 and each vertex of the second cross-sectional face 422, wherein the misalignment angle θ1 is within 10 to 30 degrees, and when the misalignment angle θ1 is a positive value, said each extending edge 423 tilts leftward and extends toward the second end of the first operating segment 42. When the misalignment angle θ1 is a negative value, said each extending edge 423 tilts rightward and extends toward the second end of the first operating segment 42. In this embodiment, the misalignment angle θ1 is the position value, and said each extending edge 423 tilts leftward and extends toward the second end of the first operating segment 42.

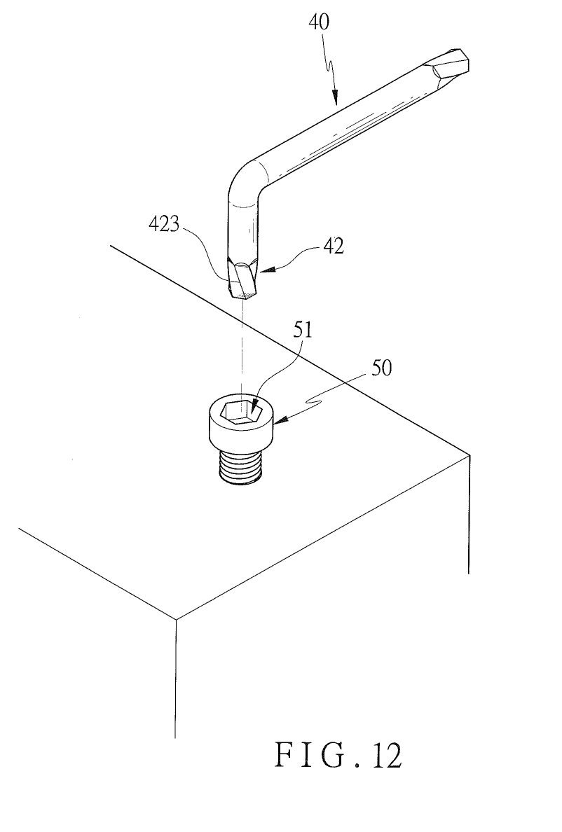

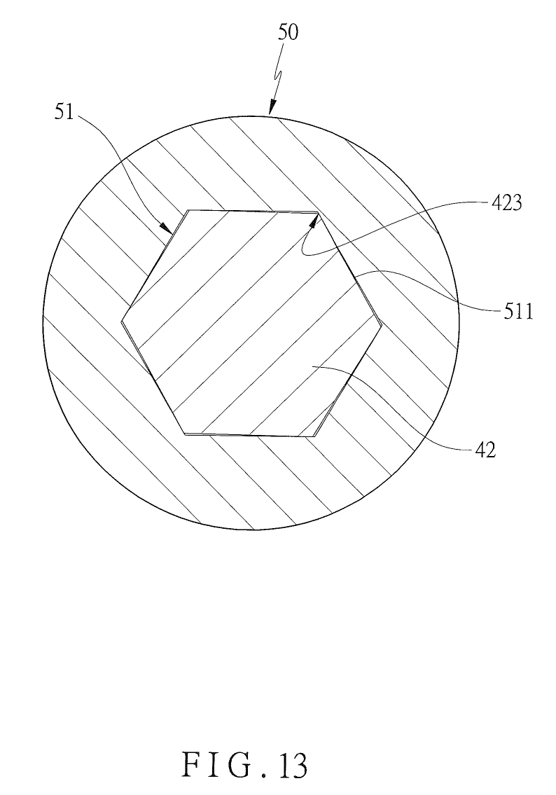

Referring to FIGS. 12 and 13, when the Allen wrench 40 is used to remove a normal screw bolt 50, the first operating segment 42 fits into a hexagonal orifice 51 of the normal screw bolt 50, and because the working part of the first operating segment 42 between the first cross-sectional face 421 and the second cross-sectional face 422 is in the cone shape, the six extending edges 423 abut against six peripheral faces 511 of the hexagonal orifice 51, and a gap between the first operating segment 42 and the hexagonal orifice 51 eliminates, when the first operating segment 42 completely fits with the hexagonal orifice 51, hence the hexagonal orifice 51 of the normal screw bolt 50 is not broken by the first operating segment 42 of the Allen wrench 40, and the normal screw bolt 50 is removed by the first operating segment 42 easily.

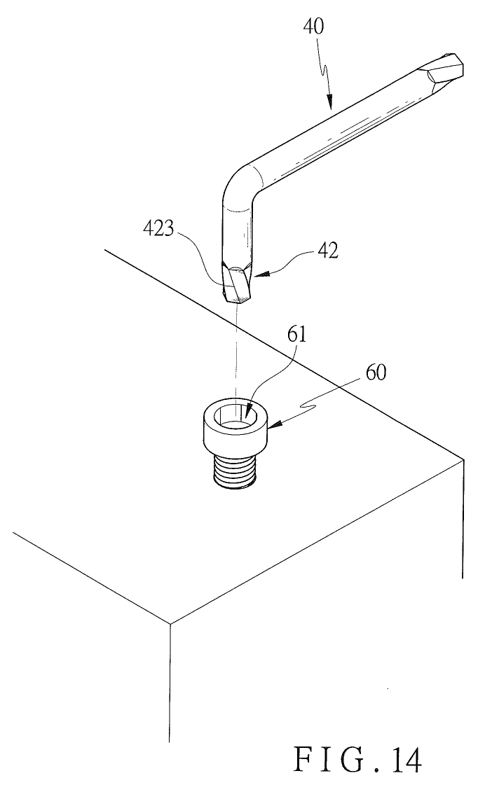

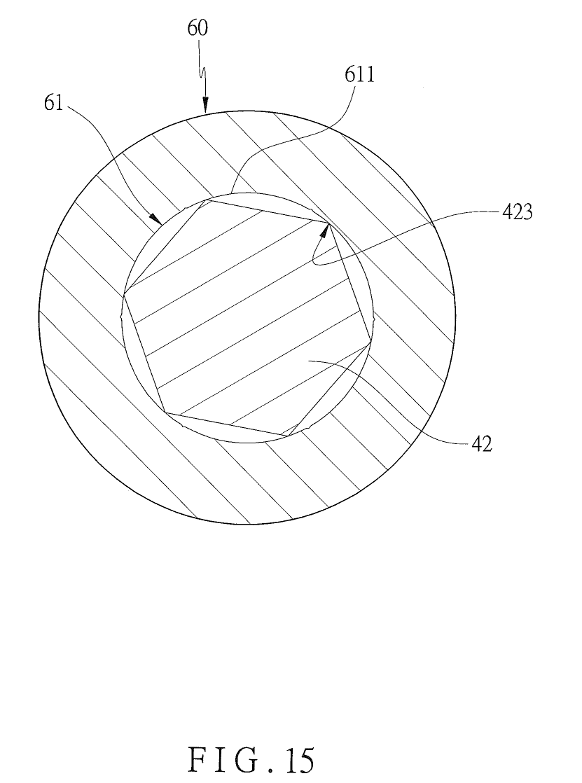

As shown in FIGS. 14 and 15, when the Allen wrench 40 is used to remove an abraded screw bolt 60, the first operating segment 42 fits into an abraded orifice 61 of the abraded screw bolt 60, and because the working part of the first operating segment 42 between the first cross-sectional face 421 and the second cross-sectional face 422 is in the cone shape, the six extending edges 423 abut against six abraded peripheral faces 611 of the abraded orifice 61 securely to remove the abraded screw bolt 60 easily. Preferably, the six extending edges 423 facilitates a fitting of the first operating segment 42 with the abraded orifice 61 so as to remove the abraded screw bolt 60 quickly.

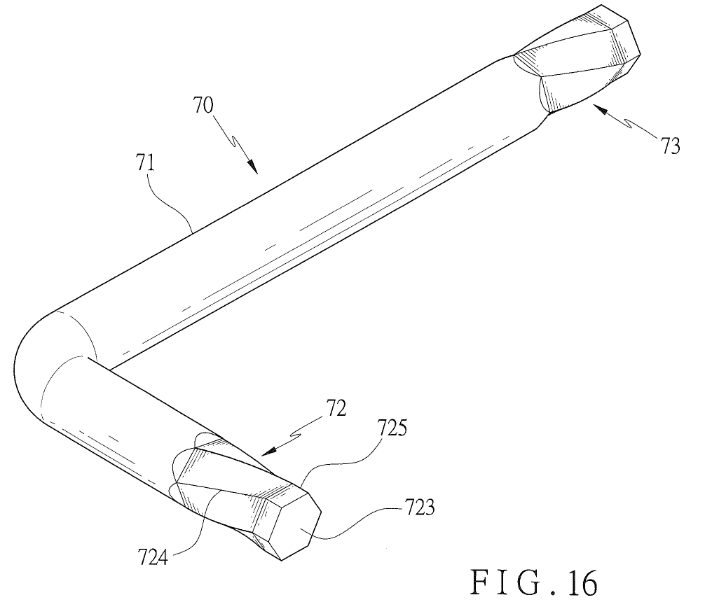

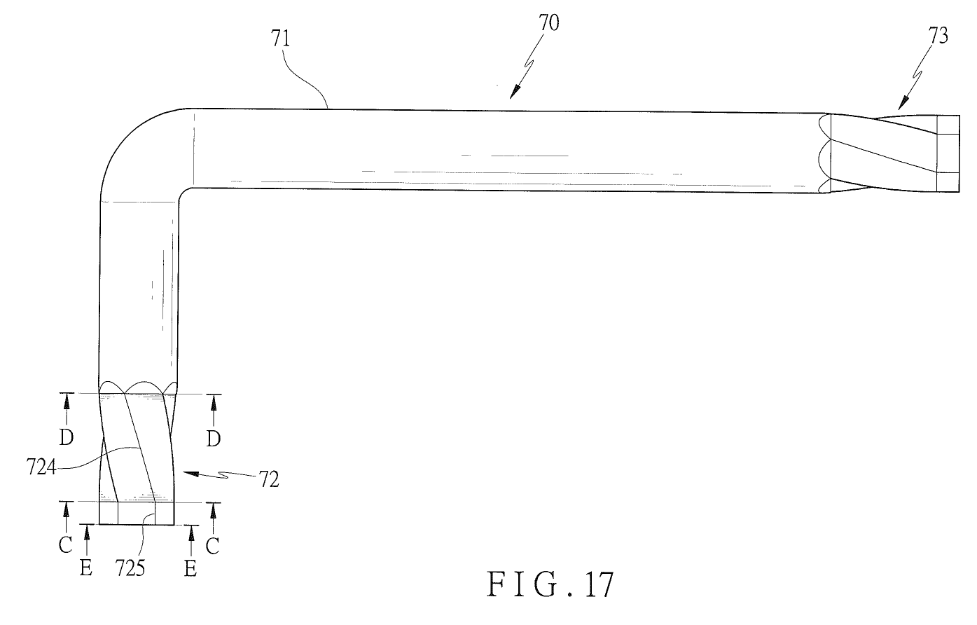

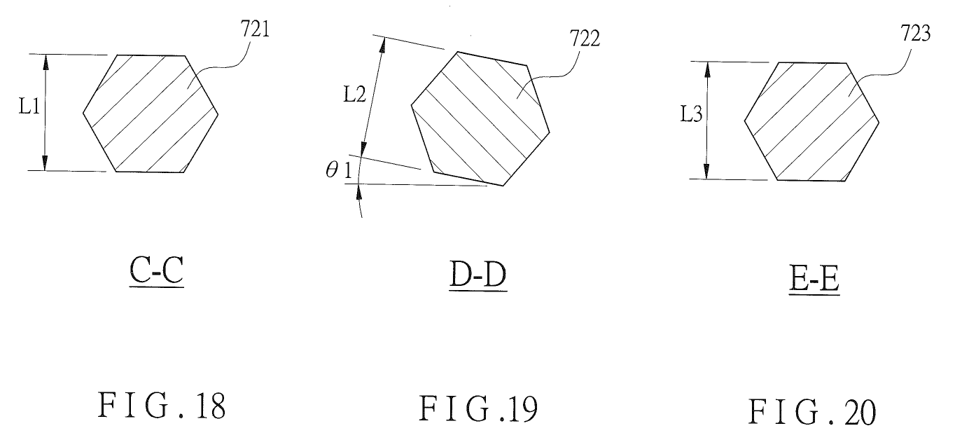

With reference to FIGS. 16 to 20, an Allen wrench 70 according to a second embodiment of the present invention comprises: at least one operating segment formed on a gripping handle 71. In this embodiment, the gripping handle 71 is in an L shape and includes a first operating segment 72 formed on a first end thereof and a second operating segment 73 formed on a second end thereof. The first operating segment 72 is formed in a hexagonal column shape and has a first cross-sectional face 721 defined on a first end thereof, a second cross-sectional face 722 defined on a second end thereof, and a third cross-sectional face 723 proximate to the first cross-sectional face 721; wherein a diameter L1 of an inscribed circle of the first cross-sectional face 721 is less than a diameter L2 of an inscribed circle of the second cross-sectional face 722, and a first working part of the first operation segment 72 between the first cross-sectional face 721 and the second cross-sectional face 722 is in a cone shape, wherein the diameter L1 of the inscribed circle of the first cross-sectional face 721 is equal to a diameter L3 of an inscribed circle of the third cross-sectional face 723, and a second working part of the first operation segment 72 between the first cross-sectional face 721 and the third cross-sectional face 723 is in a column shape, wherein the diameter L1 of the inscribed circle of the first cross-sectional face 721 is 0.8 to 0.95 times less than the diameter L2 of the inscribed circle of the second cross-sectional face 722. A misalignment angle θ1 is defined between the first cross-sectional face 721 and the second cross-sectional face 722 so that among six vertices of the first cross-sectional face 721 and six vertices of the second cross-sectional face 722 are defined six extending edges 724, and each extending edge 724 is defined between each vertex of the first cross-sectional face 721 and each vertex of the second cross-sectional face 722, wherein the misalignment angle θ1 is within 10 to 30 degrees, and when the first misalignment angle θ1 is a positive value, said each extending edge 724 tilts leftward and extends toward the second end of the first operating segment 72. When the misalignment angle θ1 is a negative value, said each extending edge 724 tilts rightward and extends toward the second end of the first operating segment 72. In this embodiment, the misalignment angle θ1 is the position value, and said each extending edge 724 tilts leftward and extends toward the second end of the first operating segment 72. Furthermore, the first cross-sectional face 721 is in alignment with the third cross-sectional face 723 so that among the six vertices of the first cross-sectional face 721 and six vertices of the third cross-sectional face 723 are defined six parallel edges 725, and each parallel edge 725 is defined between said each vertex of the first cross-sectional face 721 and each vertex of the third cross-sectional face 723.

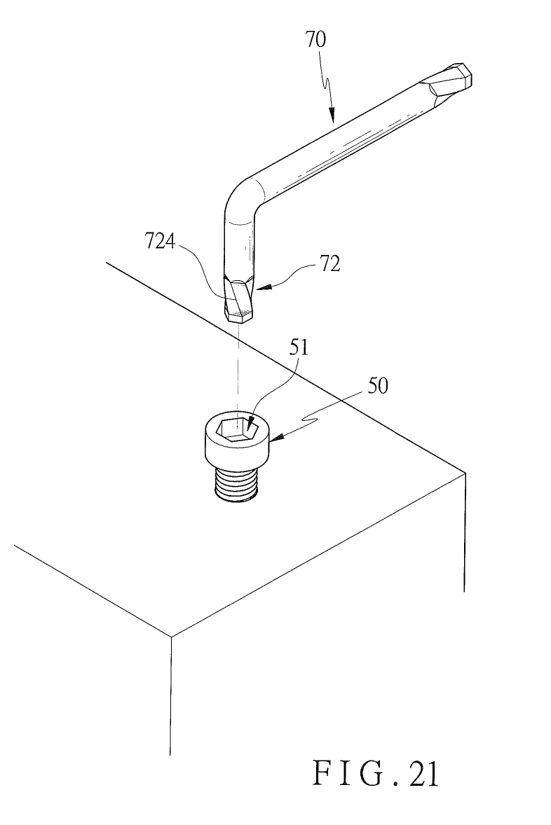

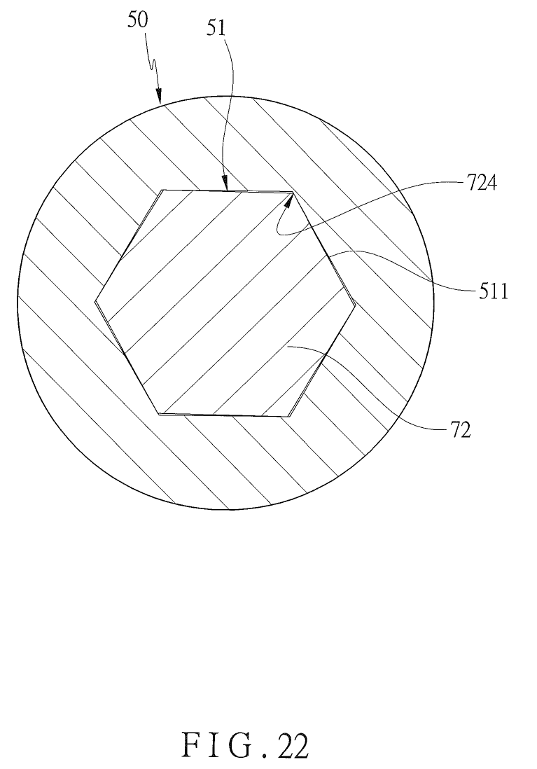

Referring to FIGS. 21 and 22, when the Allen wrench 70 is used to remove a normal screw bolt 50, the first operating segment 72 fits into a hexagonal orifice 51 of the normal screw bolt 50, and because the first working part of the first operating segment 72 between the first cross-sectional face 721 and the second cross-sectional face 722 is in the cone shape, the six extending edges 724 abut against six peripheral faces 511 of the hexagonal orifice 51, and a gap between the first operating segment 72 and the hexagonal orifice 51 eliminates, when the first operating segment 72 completely fits with the hexagonal orifice 51, hence the hexagonal orifice 51 of the normal screw bolt 50 is not broken by the first operating segment 72 of the Allen wrench 70, and the normal screw bolt 50 is removed by the first operating segment 72 easily.

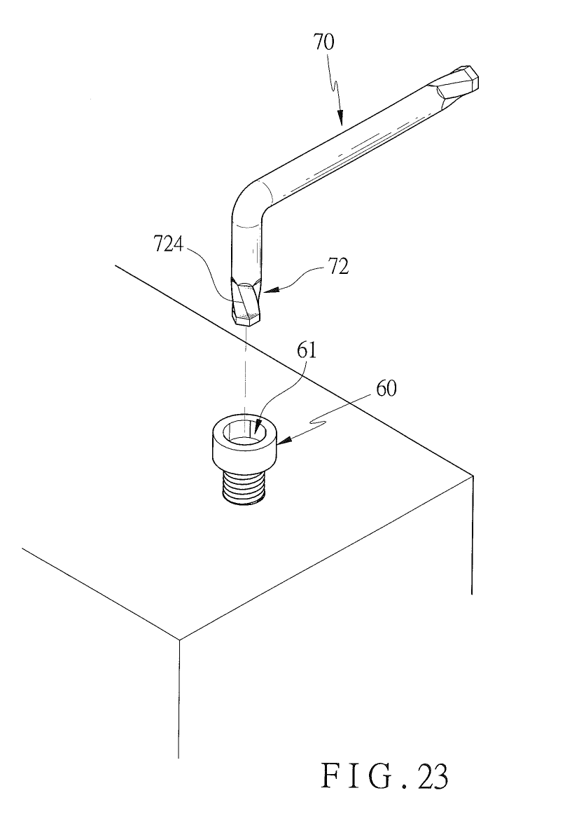

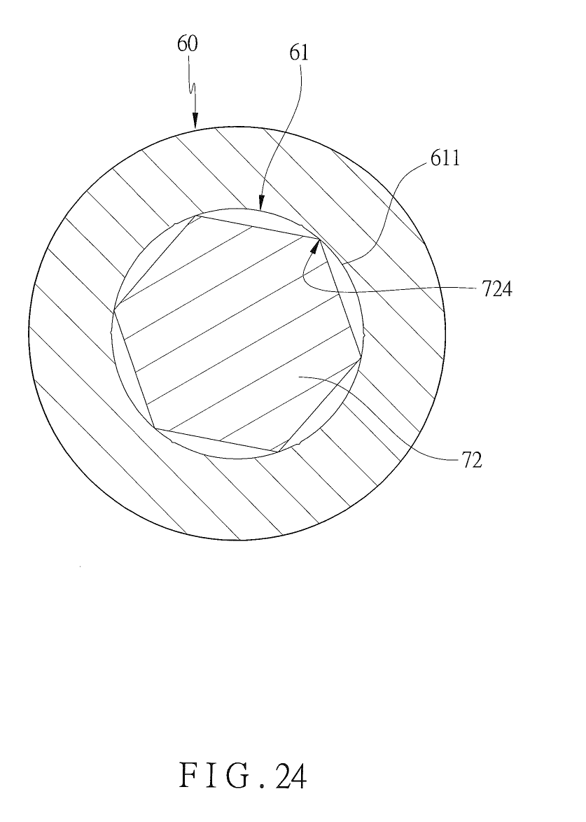

As shown in FIGS. 23 and 24, when the Allen wrench 70 is used to remove an abraded screw bolt 60, the first operating segment 72 fits into an abraded orifice 61 of the abraded screw bolt 60, and because the first working part of the first operating segment 72 between the first cross-sectional face 721 and the second cross-sectional face 722 is in the cone shape, the six extending edges 724 abut against six abraded peripheral faces 611 of the abraded orifice 61 securely to remove the abraded screw bolt 60 easily. Preferably, the six extending edges 724 facilitates a fitting of the first operating segment 72 with the abraded orifice 61 to remove the abraded screw bolt 60 quickly.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An Allen wrench structure comprising: at least one operating segment formed on a gripping handle, and the at least one operating segment having plural cross-sectional faces, each cross-sectional face being formed in a hexogen shape, a first cross-sectional face being defined on a first end of the at least one operating segment, and a second cross-sectional face being defined on a second end of the at least one operating segment;
wherein a diameter L1 of an inscribed circle of the first cross-sectional face is less than a diameter L2 of an inscribed circle of the second cross-sectional face, and a working part of the at least one operation segment between the first cross-sectional face and the second cross-sectional face is in a cone shape, and wherein a misalignment angle θ1 is defined between the first cross-sectional face and the second cross-sectional face so that among six vertices of the first cross-sectional face and six vertices of the second cross-sectional face are defined six extending edges, and each extending edge is defined between each vertex of the first cross-sectional face and each vertex of the second cross-sectional face.

2. The Allen wrench structure as claimed in claim 1, wherein the gripping handle is in an L shape and includes a first operating segment formed on a first end thereof and a second operating segment formed on a second end thereof

3. The Allen wrench structure as claimed in claim 1, wherein the diameter L1 of the inscribed circle of the first cross-sectional face is 0.8 to 0.95 times less than the diameter L2 of the inscribed circle of the second cross-sectional face.

4. The Allen wrench structure as claimed in claim 1, wherein the misalignment angle θ1 is within 10 to 30 degrees.

5. The Allen wrench structure as claimed in claim 4, wherein when the misalignment angle θ1 is a positive value, said each extending edge tilts leftward and extends toward a second end of the first operating segment.

6. The Allen wrench structure as claimed in claim 4, wherein when the misalignment angle θ1 is a negative value, said each extending edge tilts rightward and extends toward the second end of the first operating segment.

7. The Allen wrench structure as claimed in claim 1, wherein the at least one operating segment further has a third cross-sectional face proximate to the first cross-sectional face.

8. The Allen wrench structure as claimed in claim 7, wherein the diameter L1 of the inscribed circle of the first cross-sectional face is equal to a diameter L3 of an inscribed circle of the third cross-sectional face, and a working part of the first operation segment between the first cross-sectional face and the third cross-sectional face is in a column shape.

9. The Allen wrench structure as claimed in claim 7, wherein the first cross-sectional face is in alignment with the third cross-sectional face so that among the six vertices of the first cross-sectional face and six vertices of the third cross-sectional face are defined six parallel edges, and each parallel edge is defined between said each vertex of the first cross-sectional face and each vertex of the third cross-sectional face.
